(19) United States
(12) Patent Application Publication
(10) Pub. No.: US 2025/0114884 A1
(43) Pub. Date: Apr. 10, 2025

(54) TRANSFER STATION

(71) Applicant: NEWFREY LLC, New Britain, CT (US)

(72) Inventors: Manuel SCHNEIDER, Giessen (DE); Luis RODRIGO, Giessen (DE); Christof CLEMEN, Giessen (DE); Bettina FISCHERMANNS, Giessen (DE)

(21) Appl. No.: 18/982,483

(22) Filed: Dec. 16, 2024

Related U.S. Application Data
(63) Continuation of application No. PCT/EP2023/066189, filed on Jun. 15, 2023.

(30) Foreign Application Priority Data
Jun. 16, 2022 (EP) 22179443.1

(51) Int. Cl. B23P 19/06; B21J 15/36

(52) U.S. Cl. CPC B23P 19/06; B21J 15/36

(57) ABSTRACT

A transfer station for storing a plurality of drive screws. One drive screw can be taken out of the transfer station by a joining tool comprising a sleeve adapted to receive the drive screw to then carry out at least one joining operation. The transfer station having a housing longitudinally extending in height along a vertical axis X, in width along a horizontal axis Y and in depth along a depth axis Z; a sleeve holder movably connected to the housing and operable to hold and release the sleeve of the joining tool; and a magazine adapted to store the plurality of drive screws. The sleeve holder is movable between an attachment position, a filling position and a release position.

### CROSS-REFERENCE TO RELATED APPLICATIONS

This application is a continuation of PCT Application No. PCT/EP2023/066189, filed Jun. 15, 2023, which claims priority from European Patent Application No. 22179443.1, filed Jun. 16, 2022, the disclosures of which are incorporated herein by reference in their entirety.

### BACKGROUND OF THE INVENTION

The present invention is directed to a transfer station for storing a plurality of drive screws, wherein one drive screw can be taken out of the transfer station by a joining tool comprising a sleeve adapted to receive the drive screw to carry out at least one joining operation which uses the drive screw. The joining tool is for instance a setting tool for setting a blind rivet nut in a workpiece. The present invention is also directed to a system comprising a transfer station and a joining tool and to a method for transferring a new drive screw to a joining tool.

In motor vehicle manufacture it is usual that various components such as strips, rails, equipment etc. are fastened to thin-walled components, such as sheet metal or profiles of aluminium, for example. A common method of connecting components is to use a fastener having a screw thread.

Blind rivet nuts are fastening elements that are to be arranged in an opening, for example, in a through hole of a metal sheet or any other sheet or workpiece. The blind rivet nuts thereby provide an internal thread and thus render possible a screw connection to metal sheets or workpieces, the wall thickness of which is not sufficient to embody a thread. A blind rivet nut setting device or setting tool for blind rivet nuts is used to set the blind rivet nut in the opening of the workpiece. The blind rivet nut has, in a non-deformed state, a hollow cylindrical rivet shank at the one end of which a radially extending set head is embodied and on the other end of which an internal thread is formed.

It is known to use a bolt having an external thread (also called drive screw) cooperating with the internal thread of the blind rivet nut to set the blind rivet nut in the hole. The internal thread of the blind rivet nut engages with the external thread of the bolt. The blind rivet nut is inserted with the rivet shank first into the hole until the rivet head contacts the sheet. By start-up of the blind rivet nut setting device, the drive screw and thus the thread region are then moved axially backwards from the blind rivet nut and the sheet, whereby a compression of the rivet shank occurs. A bead or a bulge is formed at a desired deformation point at the workpiece side facing away from the rivet head. The blind rivet nut is thus held captively in the hole (or opening).

To remove the blind rivet nut setting device from the set blind rivet nut, pressure on the drive screw is relieved and it is rotated in the drill-off direction. The blind rivet nut setting device is then available for a new setting operation.

WO2020244753A1 from the applicant discloses an automated setting tool for automatically setting rivets (notably rivet nuts) in a workpiece. The automated setting tool comprises a drive screw projecting from the front end of the setting tool. The drive screw is for instance arranged within a sleeve and is rotationally and translationally movable along and around a longitudinal axis between a retracted position and an extended position. After several joining operation, the drive screw may show signs of wear and it is necessary to change it to avoid a faulty joining operation. There might also be a possibility to change the dimension of the drive screw, so it can be used for blind rivet nut having another diameter for example. To replace the worn drive screw, an operator has to change the drive screw manually, by entering the robot cell where the joining tool is located. This is time-consuming and may cause safety issue.

### BRIEF SUMMARY OF THE INVENTION

To mitigate those drawbacks, there is a need to automatise this drive screw changing process. It is an object of the present invention to provide a transfer station according to claim 1. More particularly, the transfer station comprises: a housing longitudinally extending in height along a vertical axis X, in width along a horizontal axis and in depth along a depth axis, a sleeve holder movably connected to the housing, the sleeve holder being adapted to hold and release the sleeve of the joining tool, a magazine adapted to store the plurality of drive screws, wherein the sleeve holder is movable between an attachment position, a filling position, and a release position.

Such transfer station allows to easily and automatically change a current drive screw from a joining tool for another one (either a new one because the current one is worn, or a drive screw having different dimension to join other fasteners). Such transfer station is compact, and can easily be connected to a joining tool.

In an embodiment, the sleeve holder is movable in rotation with regard to the housing around a holder axis between the release position and the attachment position.

In an embodiment, the sleeve holder is movable in translation with regard to the housing along a transfer axis between the filling position and the attachment position.

In an embodiment, the holder axis is parallel to the transfer axis.

In an embodiment, the sleeve holder comprises jaws adapted to receive a sleeve of a joining tool.

In an embodiment, the jaws are mounted on a carriage, and wherein the carriage is movable in translation with regard to the housing.

In an embodiment, the jaws are connected to the carriage by a first pivot.

In an embodiment, the magazine comprises a rail longitudinally extending along a rail axis, and wherein the rail axis is oriented with regard to the vertical axis at an angle between 45 degrees and 85 degrees.

In an embodiment, a transfer apparatus is provided at one end of the rail, the transfer apparatus being arranged between the rail and the sleeve holder when said sleeve holder is in the filling position.

In an embodiment, the transfer station further comprises a collecting tray for collecting a used drive screw, wherein the collecting tray is arranged below and facing the sleeve holder such that when the sleeve holder is in the release position, a drive screw can fall out of the sleeve into the collecting tray.

In an embodiment, the housing comprises a first structure elastically assembled to a second structure.

The present disclosure is also directed to a transfer station comprising a housing longitudinally extending along a vertical axis, a sleeve holder connected to the housing, the sleeve holder being adapted to hold and release the sleeve of the joining tool, a filling unit connected to the housing. The filling unit comprises a magazine adapted to store the plurality of drive screws, and a transfer apparatus for transferring one drive screw from the plurality of drive screws to the sleeve, wherein the sleeve holder is movable between a filling position and a release position, and wherein the transfer apparatus is movable between the magazine and the sleeve holder.

In an embodiment, the sleeve holder is movable in rotation with regard to the housing around a holder axis. The sleeve holder is for instance actuated by a rotary actuator arranged on the housing. The rotation of the sleeve holder allows to use gravity for removing a drive screw arranged inside a sleeve. Thus, a compact system is provided.

In an embodiment, the transfer apparatus is movable in translation with regard to the housing along a transfer axis between a takeover position and a handover position. The transfer apparatus can isolate one drive screw from a plurality of drive screw and transfer it to the sleeve. Thus, the transfer apparatus ensures two different functions. More particularly the takeover position is when the transfer station is in the vicinity of the magazine and the handover position is when the transfer station is in the vicinity of the sleeve holder.

In an embodiment, the holder axis is orthogonal to the transfer axis. The transfer axis and the holder axis may also be orthogonal to the vertical axis. This reduces the size of the transfer station.

In an embodiment, the sleeve holder comprises a holder housing connected to the housing by a first pivot. The holder housing has a first wall with a cut-out for receiving the sleeve holder and the periphery of the cut-out is provided with a locking profile adapted to apply a counter torque while assembling and disassembling the sleeve, a second wall directly connected to the housing through the first pivot, and a spring-loaded sheet rotatably connected to the holder housing. The sleeve of a joining tool is easily received in the cut-out and connected to it.

In an embodiment, the magazine is a rail comprising a base and two flanges extending from each side of the base, wherein the rail longitudinally extends along a rail axis, wherein the rail axis is oriented with regard to the vertical axis at an angle between 45 degrees and 85 degrees. The rail is inclined to use the gravity and load a drive screw in the transfer apparatus.

In an embodiment, the transfer apparatus comprises a slide having a recess adapted to receive one drive screw, and wherein the slide translates along a horizontal axis, orthogonal to the vertical axis. The recess is adapted to receive one drive screw, allowing thus the isolation of one drive screw from the plurality of drive screws arranged in the magazine.

In an embodiment, the slide is movable inside a transfer housing, the transfer housing having a bottom comprising an opening, and wherein the opening is arranged facing the sleeve holder. The opening is aligned with the sleeve holder, such that when the sleeve holder receives the sleeve, the opening is aligned with the sleeve and a drive screw can fall from the slide into the sleeve.

In an embodiment, the transfer station comprises a collecting tray for collecting a used drive screw, wherein the collecting tray is arranged below and facing the sleeve holder such that when the sleeve holder is in a release position, a drive screw can fall out of the sleeve into the collecting tray. In another embodiment, the released drive screw could be collected in another magazine in order to eventually be re-used later.

The present invention is also directed to a system comprising a transfer station and a joining tool with a drive screw and a drive screw sleeve, and wherein the sleeve holder and the drive screw sleeve have complementary locking profiles. For instance, the sleeve of the tool and the sleeve holder have a multi-tooth geometry that matches to each other. The multi-tooth applies a counter torque while assembling and disassembling.

In an embodiment, the sleeve holder is elastically movable along the vertical axis. This allows the complementary profiles to match each other.

In an embodiment, the housing comprises centering and/or guiding elements to guide the joining tool in order to align the sleeve and the sleeve holder.

In an embodiment, the system further comprises a plurality of drive screws arranged in the magazine, wherein the drive screws each comprises a shaft and a flange, and wherein the flange is supported by the magazine and the shaft protrudes from the magazine, and wherein the shafts extend parallel to the vertical axis. The drive screws are suspended and easily guided within the magazine.

Finally, the present invention is directed to a method for changing a drive screw of a joining tool, comprising the steps of: providing a joining tool with a first drive screw and a drive screw sleeve, providing a transfer station according to any of claims 1 to 9 with at least one second drive screw arranged in the magazine, moving the joining tool such that the drive screw sleeve is inserted in the sleeve holder, locking the drive screw sleeve to the sleeve holder, disconnecting the drive screw sleeve and the first drive screw from the rest of the joining tool, moving the joining tool without the drive screw sleeve and the first drive screw at a non-zero distance from the sleeve holder, the drive screw sleeve and the first drive screw, moving the sleeve holder in the release position such that the first drive screw is removed from the drive screw sleeve, moving the sleeve holder in the filling position, transferring a second drive screw from the magazine to the drive screw sleeve, moving the sleeve holder in the attachment position, connecting the joining tool to the drive screw sleeve, releasing the drive screw sleeve from the sleeve holder such that the joining tool can carry out at least one joining operation which uses the second drive screw.

Such method allows an easy and quick replacing of a drive screw from a joining tool, fully automatized.

In an embodiment, the sleeve holder turns up to 180 degrees. In an embodiment, the drive screw is lifted inside the sleeve by a spring-loaded sheet to allow a male hexagonal pin of the joining tool to engage with a female hexagonal feature of the drive screw.

### BRIEF DESCRIPTION OF THE SEVERAL VIEWS OF THE DRAWING

Other characteristics and advantages of the invention will readily appear from the following description of embodiments, provided as non-limitative examples, in reference to the accompanying drawings.

FIG. 1 shows a perspective view of a transfer station according to a first embodiment of the invention and a joining tool schematically represented;

FIG. 2 shows a detailed view of a sleeve holder and the adjacent structures of the transfer station of FIG. 1;

FIG. 3 shows a perspective view of a drive screw adapted to be use in a joining tool and which can be stored in the transfer station of FIG. 1;

FIG. 4 shows a perspective view of a sleeve adapted to receive the drive screw of FIG. 3;

FIG. 5A is a perspective view of the transfer station of FIG. 1 with the joining tool connected to the transfer station in a first position;

FIG. 5B is a detailed view of the sleeve holder when the joining tool is connected to the transfer station in the first position of FIG. 5A;

FIG. 6A is a perspective view of the transfer station of FIG. 1 with the joining tool connected to the transfer station in a second position;

FIG. 6B shows the sleeve holder when the joining tool is connected to the transfer station in the second position of FIG. 6A;

FIG. 7 shows the sleeve holder gripping the sleeve of the joining tool;

FIG. 8A is a perspective view of the transfer station of FIG. 1 with the sleeve connected to the sleeve holder and the rest of the joining tool disconnected from the transfer station;

FIG. 8B shows the sleeve holder holding the sleeve, the rest of the joining tool being at distance from the sleeve, and the sleeve comprising a drive screw;

FIG. 9 shows the sleeve holder in a release position, the drive screw being removed from the sleeve;

FIG. 10A and FIG. 10B show the transfer station with the sleeve holder holding the empty sleeve back in an attachment position;

FIG. 11A and FIG. 11B show the transfer station with the sleeve holder in a filling position;

FIG. 12 show the transfer station with the sleeve holder in the filling position of FIG. 11A and FIG. 11B and a new drive screw being inserted into the sleeve;

FIG. 13A and FIG. 13B show the transfer station with the sleeve holder in the attachment position;

FIG. 14 shows the joining tool being re-assembled to the sleeve with the new drive screw, the sleeve holder retaining the sleeve during the assembly;

FIG. 15 shows the sleeve holder releasing the sleeve to allows the joining tool with the new drive screw to continue a joining process;

FIG. 16 shows the joining tool disconnected from the transfer station;

FIG. 17A and FIG. 17B show the guiding and centring elements of the transfer station in more details;

FIG. 18 shows a perspective view of a transfer station of FIG. 1 according to a second embodiment;

FIG. 19 is a detailed view of the sleeve holder of the transfer station of FIG. 18;

FIG. 20 shows the transfer station of FIG. 18 with the drive screw released from the sleeve and lying in a bin container;

FIG. 21 shows the transfer station of FIG. 18 with the sleeve holder holding an empty sleeve;

FIG. 22 shows a filling unit of the transfer station of FIG. 18 facing the sleeve to re-load a new drive screw in the sleeve;

FIG. 23 is a detailed view of a portion of the filling station of FIG. 22 with a drawer adapted to move a drive screw from a magazine to the drive screw;

FIG. 24 shows the transfer station of FIG. 18 after re-fill, ready to be connected to the rest of the joining tool;

FIG. 25 shows a perspective view of a transfer station according to a third embodiment with a joining tool;

FIG. 26 shows the transfer station of the FIG. 25 with a portion of the joining tool in a front view.

### DETAILED DESCRIPTION OF THE INVENTION

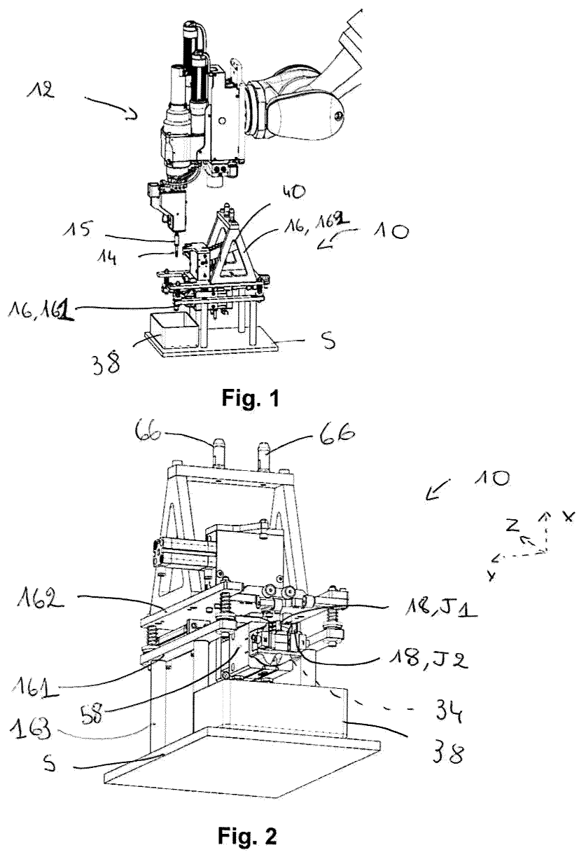

FIGS. 1, 2, 5A, 5B, 6A, 6B, 7, 8A, 8B, 9, 10A, 10B, 11A, 11B, 12, 13A, 13B, 14, 15, 16, 17A, 17B show a first embodiment of the transfer station according to the invention.

FIG. 1 shows a transfer station 10 and a portion of a joining tool 12. The aim of the transfer station 10 is to store a plurality of drive screws 14 and to transfer or load one of the plurality of drive screws 14 to the joining tool 12 when needed. For instance, a new drive screw 14 can be needed when the current drive screw 14 used by the joining tool 12 is worn out, damaged, has already completed a pre-determined number of joining operation or does not have the required geometry for its next joining operation. The transfer station 10 is adapted to unload the damaged or old drive screw and to replace it by a new one, such that the joining tool 12 can continue its joining process.

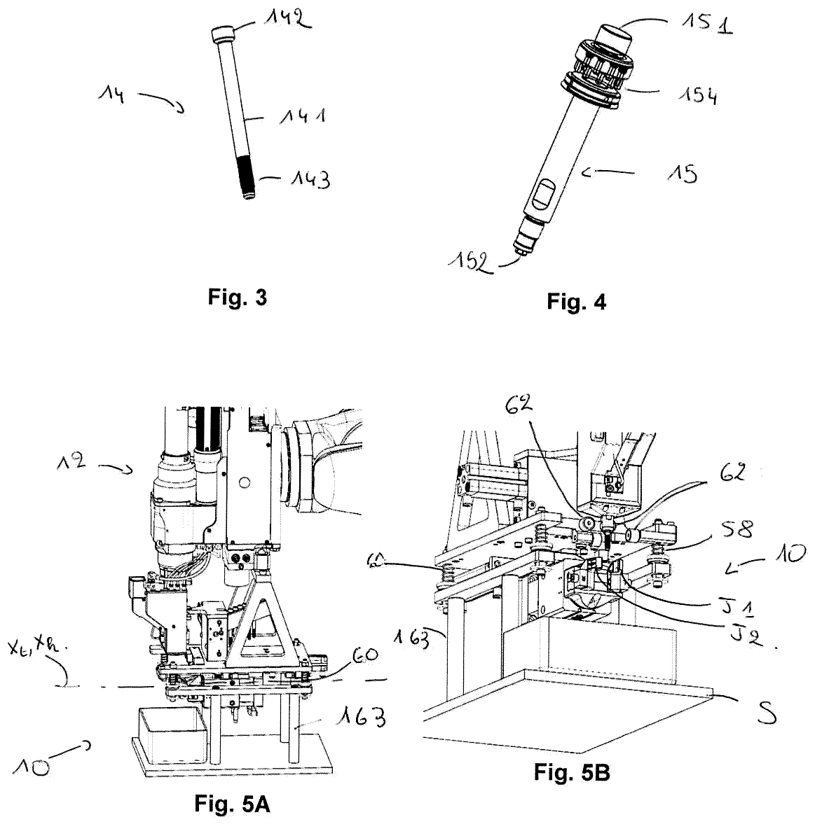

The joining tool 12 comprises in a known manner a tool head H with a drive screw sleeve 15. The drive screw sleeve 15 comprises a first end connected to the rest of the tool and a second free end. The drive screw sleeve 15 longitudinally extends between the first and the second end. Inside the drive screw sleeve 15 is arranged a drive screw 14. The drive screw 14 partially protrudes from the second end of the drive screw sleeve 15. The drive screw 14 is for instance depicted in more detail in FIG. 3. The drive screw 14 extends longitudinally and comprises a shaft 141 and a flange 142. At a first end of the shaft 141 is arranged a threaded segment 143. The flange 142 is arranged at a second end of the shaft, opposite the first end. The flange 142 extends radially outward from the shaft 141. The threaded segment 141 (or at least part of it) extends outside the drive screw sleeve 15. FIG. 4 shows more particularly the drive screw sleeve 15. The drive screw sleeve 15 is adapted to receive the drive screw 14. The drive screw sleeve 15 has a sensibly cylindrical body, with a first opening 151 at a first end adapted to insert the drive screw 14, and a second opening 152 at a second end. The threaded portion 143 of the drive screw 14 protrudes from the second opening 152. As seen in FIG. 4, the cylindrical body may have two different diameters in cross-section. A sleeve locking profile 154 is arranged on the cylindrical body at the vicinity of the first opening 151. The sleeve locking profile 154 is adapted to engage a complementary locking profile on the transfer station 10. The of the sleeve can be adapted and may depend on the joining tool, the type of screws,

As depicted in FIG. 1 the transfer station 10 comprises a housing 16 longitudinally extending in height along a vertical axis X. The housing 16 extends in width along a horizontal axis Y. the housing also extends in depth along a depth axis Z. The housing 16 is destined to be fixed to a horizontal support S or to the ground. A sleeve holder 18 is connected to the housing 16.

The sleeve holder 18 is better seen in FIG. 2. The sleeve holder 18 comprises for instance movable jaws J1, J2 adapted to move between an open and a closed position. The motion of the sleeve holder or jaws can be controlled by an actuator. The jaws can move in translation or in rotation to move from the closed position to the open position and vice-versa. The sleeve holder 18 is mounted on a carriage 58. The sleeve holder 18 (and more particularly the jaws) is rotatably mounted on the carriage 58. For instance, a first pivot is arranged between the jaws (or the sleeve holder) and the carriage. The first pivot 34 allows for instance a 180-degree rotation. In other embodiments, 360-degree rotation may also be implemented. More generally, the sleeve holder 18 is movable in rotation with regard to the housing 16 around a holder axis. The carriage 58, to which is fixed the sleeve holder is movable with regard to the housing 16. More particularly the carriage is movable in translation along a transfer axis. The sleeve holder 18 can thus, through the carriage be moved in translation along the transfer axis. The transfer axis Xt is parallel to the holder axis Xh. The housing 16 comprises a first part 161 adapted to be fixed to the support S and a second part 162, above the first part and fixed to the first part. The first part comprises posts or feet 163 contacting the support S. The first part is fixed to the second part through an elastic connection 60. More particularly four connection points are provided between the first part 161 and the second part 162 and at some or each connection point a spring is arranged to allow the second part 162 to be flexible (compensate tolerances) with regard to the first part 161. More particularly the second part 162 can move in the direction of the vertical axis X with regard to the first part.

The carriage 58 is for instance fixed to the first part 161. Thus, the sleeve holder 18 or jaws J1, J2 are also fixed to the first part. The carriage 58, fixed to the first part is movable in translation along the transfer axis Xt below the second part 162. The second part 162 is provided with centring and guiding elements 62. The centring and guiding elements 62 guide and centre the joining tool when it needs to be docked to the transfer station 10, such that the joining tool is guided toward its correct docking position. FIG. 17A and FIG. 17B show in more details centring and guiding elements 62. For instance, the housing 16 is provided with rolls 62 to guide and centres the joining head of the joining tool. For instance, four rolls 62 are provided for guiding and centring the joining head for its correct positioning with regard to the transfer station 10. A guiding plate 64 (visible in FIG. 17B) may also be fixed to the joining tool to cooperate with the rolls. The rolls 62 are for instance positioned at a front of the housing and around a recess 66 adapted to receive the joining head such that they can guide the joining head until the joining tool is docked to the transfer station 10 and the sleeve 15 is positioned between the jaws. The second part 162 of the housing also comprises pins 68 extending upwards from the housing and adapted to cooperate with corresponding holes (or bushing) inside the joining tool. The pins 68 helps the joining tool to dock the transfer station 10 and avoid unwanted motion of the joining tool during the disengagement of the sleeve from the joining tool. Stopper plate on the joining tool and stopper screw on the front end of the transfer station 10 may also be provided.

The transfer station 10 may comprise a collecting tray 38 arranged below the sleeve holder 18 and adapted to receive a used drive screw 14.

A filling unit 20 is connected to the housing 16. As depicted on the figures, the sleeve holder 18 may be arranged between the support S and the filling unit 20, when seen along the vertical axis X. In other words, the filling unit 20 is arranged above the sleeve holder 18. Mare particularly, the carriage is adapted to move below the filling unit 20. The filling unit 20 comprises a magazine 36 adapted to store a plurality of drive screws 14. The magazine 36 for example comprises a rail 40 with a base 42 and two flanges 44 extending from each side of the base 42. The rail 40 extends longitudinally along a rail axis Xr and is adapted to receive a plurality of drive screws 14. The base 42 of the rail 40 comprises a slot, and the shafts 141 of the drive screw 14 can extend outside the slot. More particularly, the rail 40 is adapted to receive the flanges 142 of the drive screws 14 are adapted to contact the rail and the shafts 141 extends outside of the rail 40. Thus, the drive screws 14 are hung and their shafts extend sensibly parallel to the vertical axis X. The length of the rail 40 along the rail axis Xr is adapted to receive a plurality of drive screws and depends on the number of drive screws 14 necessary. The rail 40 may be inclined. For instance, the rail axis Xr is oriented with regard to the vertical axis X at an angle between 45 degrees and 85 degrees. The rail 40 has a first free end, for instance for loading the drive screws, and a second end, opposite the first end, connected to a transfer apparatus 46.

The filling unit 20 further comprises the transfer apparatus 46 for transferring one drive screw 14 from the magazine 36 to the drive screw sleeve 15 of a joining tool when the joining tool is docked to the transfer station. The transfer apparatus 46 comprises for example a recess in which a drive screw can fall. A door can be opened to let the drive screw nearest from the second end to fall or be transferred in the transfer apparatus. The door can be closed to prevent the last drive screw the closest to the second end to enter the transfer apparatus.

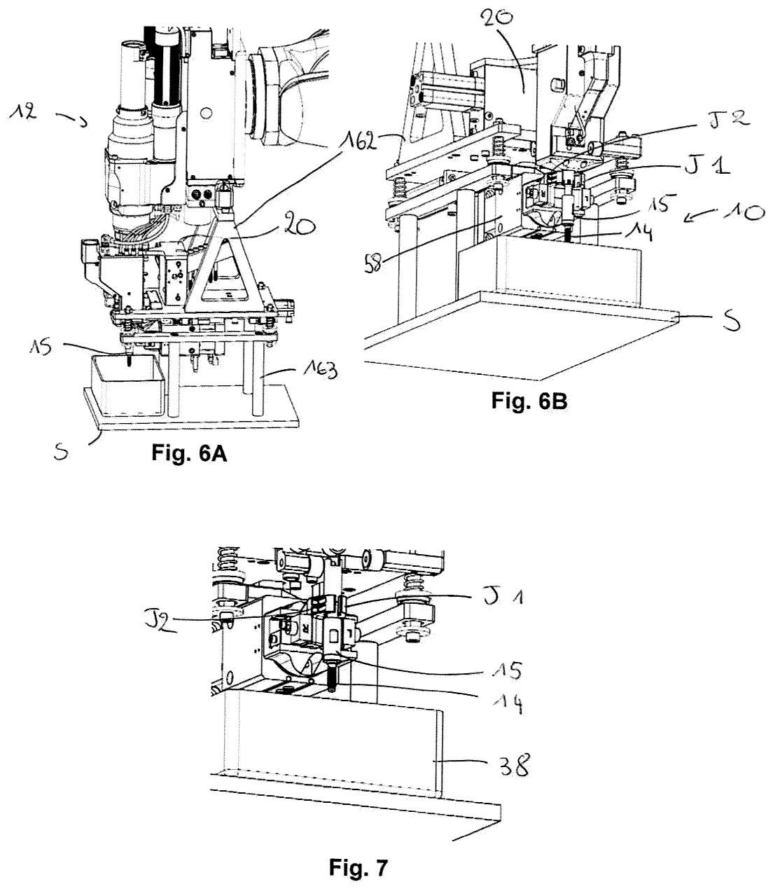

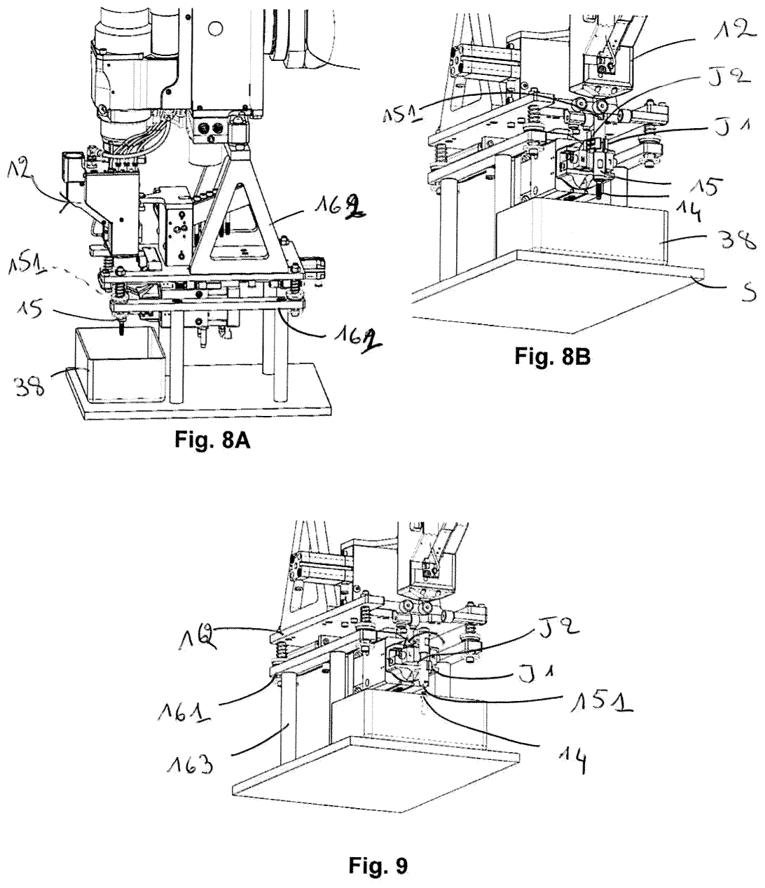

The transfer station 10 as disclosed above is used to change a drive screw 14 from the joining tool 12. More particularly when the drive screw 14 used by the joining tool 12 does not fulfil the requirements needed for the next joining operation, the joining tool 12 may be directed (for instance by an industrial robot arm) toward the transfer station 10, as depicted in FIG. 1. The transfer station, in a “rest” position is shown in FIG. 2. To dock the joining tool 12 to the transfer station 10, the joining head is positioned above the transfer station with the pins of the transfer station aligned with the corresponding holes in the joining tool. The joining head is aligned with the recess adapted to receive the joining head. The joining tool is then translated along the vertical axis toward the transfer station such that the joining tool engages the pins and the joining head cooperates with the rolls, as visible in FIG. 5A and FIG. 5B. The joining head is moved down to the point where the sleeve is arranged between the jaws or at the level of the sleeve holder and the joining tool 12 is in abutment for example with a portion of the housing of the transfer station, as depicted in FIG. 6A. The joining head of the joining tool 12 is aligned with the sleeve holder 18 (and more particularly the jaws) and the drive screw sleeve (with the drive screw inside) is inserted within the sleeve holder (and more particularly between the jaws), as visible in FIG. 6A and FIG. 6B. The jaws are first in an open position (as shown in FIG. 6B). The sleeve holder or jaws can move from the open position to the closed position such that the jaws or sleeve holder engage the sleeve locking profile 154 of the sleeve. The second part of the housing is able to move elastically downwards to allow the sleeve holder and the sleeve to engage with each other. A sensor may be provided to ensure the correct positioning of the joining tool and/or of the sleeve with regard to the transfer station 10. FIG. 7 shows in more detail the cooperation between the sleeve and the sleeve holder. Once the joining tool is docked to the transfer station and the sleeve holder is engaged with the sleeve, the sleeve can be disconnected or disengaged from the rest of the joining head. For instance, a rotational motion within the joining head can unscrew the sleeve from the rest of the joining head, the sleeve remaining engaged with the sleeve holder. A spindle of the joining tool can rotate anti-clock-wise and the upper head of the joining tool can move backwards once the thread between the sleeve or drive screw and the rest of the joining tool (or upper head of the joining tool) is disconnected. Once the sleeve has been disengaged from the rest of the joining head and is held firmly in the sleeve holder, the joining tool 12 can be moved back to another position at (short) distance from the transfer station 10, wherein the drive screw sleeve 15 and the drive screw 14 stay connected to the transfer station 10, as shown in FIG. 8A and FIG. 8B. The rolls guide the rest of the joining tool or joining head (i.e. the joining head without the sleeve and the drive screw) out of the transfer station 10. The sleeve is then in an attachment position (the first opening 151 points upwards, away from the support).

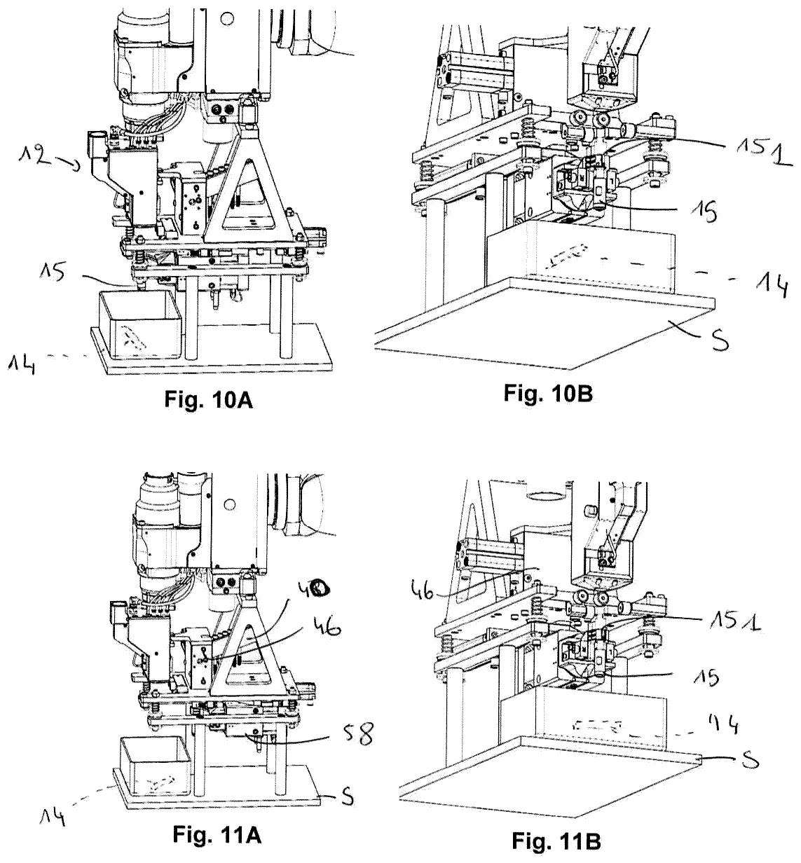

In a subsequent step, as depicted in FIG. 9, the sleeve holder 18 can move from the attachment position (which corresponds to the first opening 151 pointing upward) to a release position. More particularly, the sleeve holder 18 rotates, for example at an angle of 180 degrees, such that the first opening 151 points downward, and the drive screw 14 can fall (by gravity) from the drive screw sleeve 15 into the collecting tray 38, as illustrated in FIG. 7, FIG. 8A and FIG. 8B, or any other apparatus adapted to collect the used drive screw. Once the used drive screw 14 has fallen and the drive screw sleeve 15 is empty, the sleeve holder 18 can turn back in its attachment position (with the first opening 151 pointing upwards). A sensor, for instance a ring sensor or a proxi switch can be arranged to confirm that the drive screw has left the sleeve. The sleeve holder 18 is now ready to receive a new drive screw 14 (see FIGS. 11A and 11B).

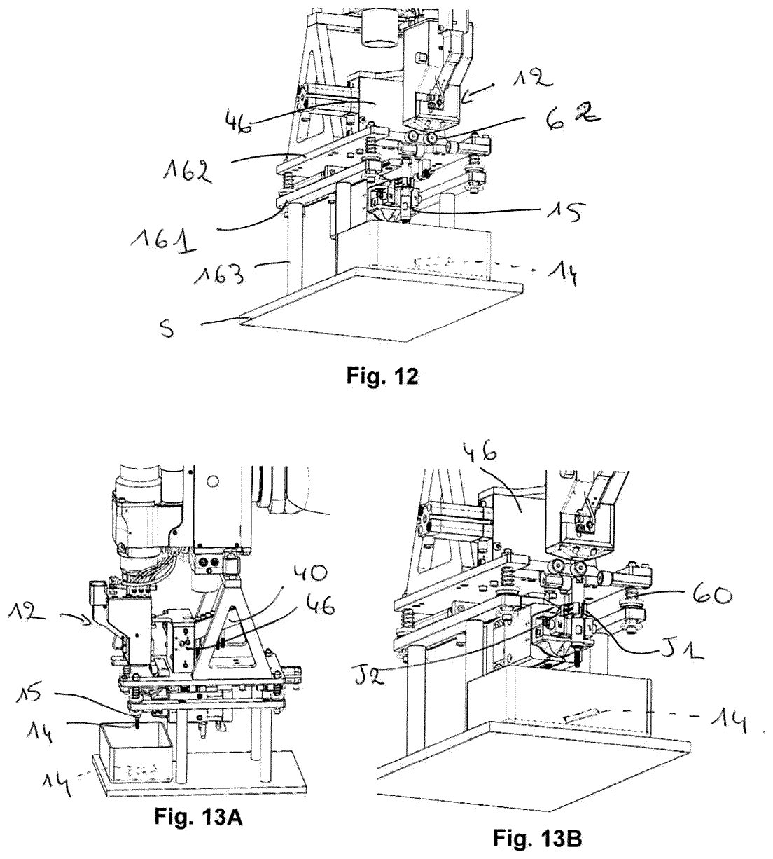

In order to fill the drive screw sleeve 15 with the new drive screw 14, the filling unit may first isolate one drive screw from the plurality of drive screws 14 arranged on the rail 40. The sleeve holder 18, through the carriage is translated from the attachment position to a filling position, as visible in FIG. 12. The filling position corresponds to a retracted position. In the filling position, the first opening 151 points upward and is aligned with the transfer apparatus 46 such as to receive a new drive screw. The sleeve holder and the sleeve are not arranged in the recess anymore, but are moved below the second housing part, and more particularly below the transfer apparatus 48. The new drive screw 14 may fall by gravity within the sleeve holder. A sensor or a proximity switch may be arranged to confirm that a new drive screw has been inserted within the sleeve.

A hole 56 of a transfer housing 53 is for instance aligned with the first opening 151 and with the longitudinal axis of the drive screw sleeve 15. The new drive screw 14 can fall into the drive screw sleeve 15 (FIG. 12).

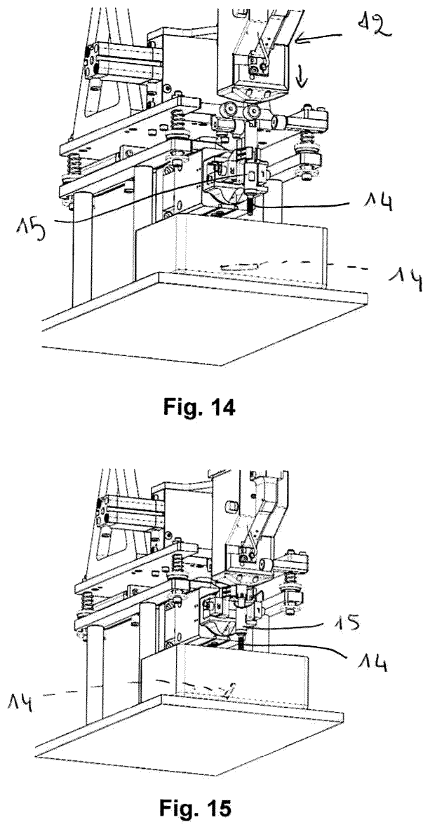

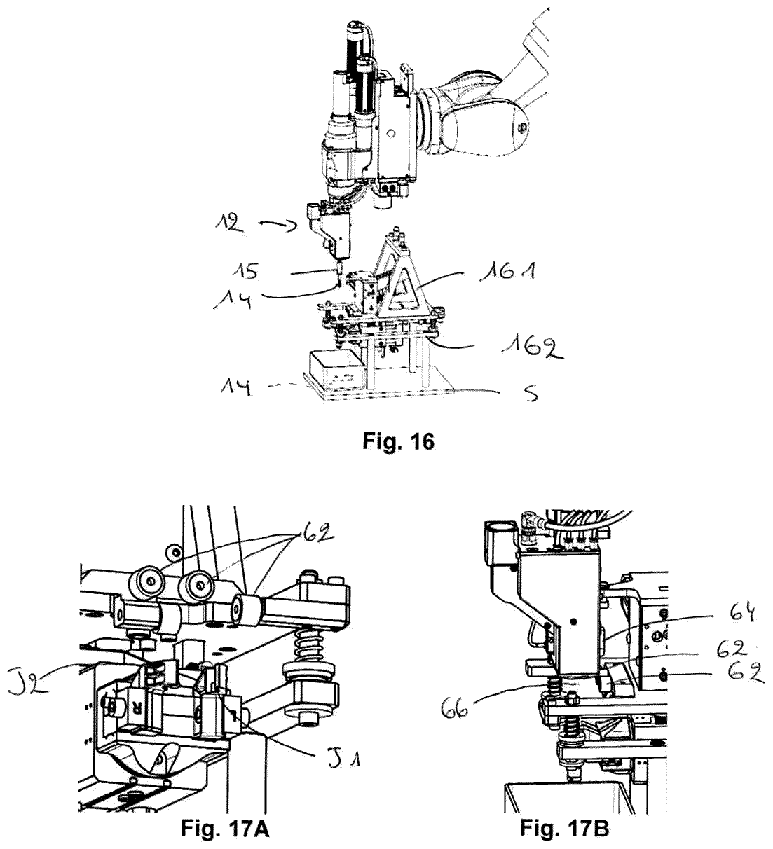

The sleeve holder can then move back to the attachment position with the drive screw sleeve 15 and the new drive screw 14, as seen in FIG. 13A and FIG. 13B. The joining tool 12 can re-engage with the drive screw sleeve by moving forward the sleeve holder using the guiding and centring elements as depicted in FIG. 14. FIG. 15 shows the joining tool engaged with the sleeve comprising the new drive screw. The joining tool can then go back to perform the next joining operation, as visible in FIG. 16.

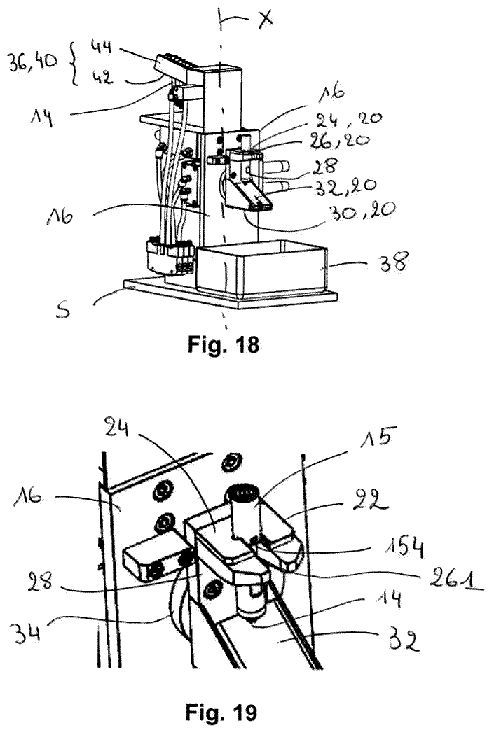

In the second embodiment, depicted in FIGS. 18 to 24, the sleeve holder 18 and a filling unit 20 are connected to the housing 16. More particularly, the housing 16 may have a sensibly parallelepiped shape and the sleeve holder 18 is arranged at one side of the housing 16, wherein the filling unit 20 is arranged at an opposite side of the housing 16 and/or above the sleeve holder 18. FIG. 18 shows a perspective view of the transfer station 10 according to the second embodiment, the transfer station of FIG. 18 having a sleeve holder already engaging a sleeve of a joining tool.

The sleeve holder 18, as depicted in FIG. 19, comprises a holder housing 22 with a first wall 24 with a cut-out 26, a second wall 28 connected to the housing 16 and extending in a cross section along the vertical axis X. A third wall 30 orthogonal or sensibly orthogonal to the second wall 28. The second wall 28 is fixed to the first wall 24 at a first end. The third wall 30 is fixed to the second wall 28 at a free end. A spring-loaded sheet 32 is rotatably connected to the third wall 30. More particularly the spring-loaded sheet 32 is connected to a free end of the third wall 30, opposite the second wall 28. The spring-loaded sheet 30, in a rest position, extends inclined with regard to the second wall 28. The spring-loaded sheet 32 is movable, under constraint, in the direction of the third wall 30 and due to a spring is adapted to go back to its rest position. The cut-out 26 is provided with a holder locking profile 261. The holder locking profile 261 is adapted to engage the sleeve locking profile 154 disclosed above, as illustrated in FIG. 19. The sleeve and/or holder locking profile(s) 154, 261 could comprise indentations or any other means which form a mechanical locking in rotation and/or in translation between both the drive screw sleeve 15 and the drive screw 14. For instance, a multi-tooth profile is provided. The holder housing 22 is connected to the housing 16 by a first pivot 34. The first pivot 34 and the holder housing 22 form the sleeve holder 18. More particularly the first pivot extends between the housing 16 and the second wall 28. Thus, the sleeve holder 18 (and holder housing 22) is rotatably attached to the housing 16.

The transfer station 10 may comprise the collecting tray 38 arranged below the sleeve holder 18 and adapted to receive a used drive screw 14. In another embodiment (not represented) a second magazine may be provided and connected to the sleeve holder for receiving the used drive screw.

The filling unit 20 is connected to the housing 16. As depicted on the FIGS. 18 to 24, the sleeve holder 18 may be arranged between the support S and the filling unit 20, when seen along the vertical axis X. In other words, the filling unit 20 is arranged above the sleeve holder 18. The filling unit 20 comprises a magazine 36 adapted to store a plurality of drive screws 14. The magazine 36 for example comprises the rail 40 with a base 42 and two flanges 44 extending from each side of the base 42. The rail 40 extends longitudinally along a rail axis Xr and is adapted to receive a plurality of drive screws 14. The base 42 of the rail 40 comprises a slot, and the shafts 141 of the drive screw 14 can extend outside the slot. More particularly, the rail 40 is adapted to receive the flanges 142 of the drive screws 14, such that the flanges 142 of the drive screws 14 rests against the base of the rail 40 and the shafts 141 extends outside of the rail 40. Thus, the drive screws 14 are hung and their shafts extend sensibly parallel to the vertical axis X. The length of the rail 40 along the rail axis Xr is adapted to receive a plurality of drive screws and depends on the number of drive screws 14 necessary. The rail 40 may be inclined. For instance the rail axis Xr is oriented with regard to the vertical axis X at an angle between 45 degrees and 85 degrees. The rail 40 has a first free end, for instance for loading the drive screws, and a second end, opposite the first end, connected to a transfer apparatus 46.

The filling unit 20 further comprises the transfer apparatus 46 for transferring one drive screw 14 from the magazine 36 to the drive screw sleeve 15. The transfer apparatus 46 comprises for example a drawer 48 movable in translation between a takeover position and a handover position. In the takeover position the drawer 48 is facing the second end of the rail 40 (such that it can receive a drive screw falling from the rail by gravity), and in the handover position, the drawer may extend above the sleeve holder. The drawer slides from the takeover position to the handover position and back from the handover position to the takeover position. For instance, an actuator 50 controls the motion of the drawer 48. Eventually, the drawer 48 may have a rest position and it may elastically return to the rest position. In another embodiment, the motion of the drawer 48 is entirely controlled by the actuator 50. The drawer 48 comprises a recess 52 adapted to receive one drive screw 14. The drawer 48 slides within a transfer housing 53. The filling unit 20 and/or the drawer can be movable in translation between a retracted position and a fill position. For instance, a second actuator 54 can move the filling unit 20 and/or the drawer 48 from the retracted position to the fill position. In the retracted position, the drawer 48 is not aligned with the sleeve holder 18, whereas in the fill position the drawer 48 is longitudinally aligned with the sleeve holder 18. The transfer housing 53 comprises a hole 56, adapted to receive a drive screw 14. More particularly, the recess 52 within the drawer 48 does not have a base and when the drawer 48 is facing the hole 56, the drive screw 14 inside the drawer 48 can fall in the direction of the sleeve holder 18 by gravity. More particularly the drive screw 14 can fall sensibly along the longitudinal axis X.

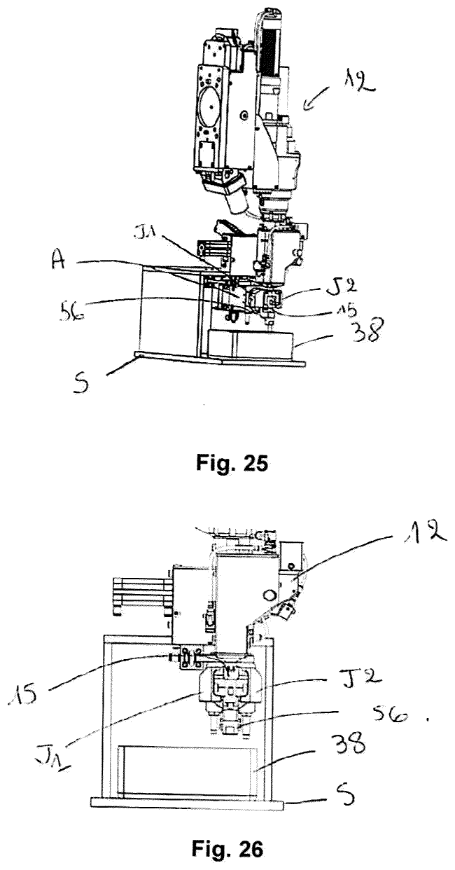

FIG. 25 and FIG. 26 show a transfer station 10 according to a third embodiment and the joining tool 12 with the filling unit of the second embodiment and the sleeve holder having jaws, similar to the first embodiment. The transfer station 10 comprises the housing 16 longitudinally extending along the vertical axis X. The housing 16 is destined to be fixed to a vertical support S or to the ground. The sleeve holder 18 and the filling unit 20 are connected to the housing 16. More particularly the sleeve holder 18 is arranged below the filling unit 20. For instance, the housing 16 comprises a structure being a hollow parallelepiped with a cavity and the sleeve holder is partially arranged in the cavity. The filling unit is arranged above the hollow parallelepiped.

As seen in FIG. 25 and FIG. 26, the sleeve holder 18 comprises a first and a second jaw J1, J2, adapted to move between a locked position and an unlocked position. For instance, a jaw actuator A moves the first and/or the second jaws between the locked position and the unlocked position. The jaw actuator A may move the jaw(s) J1, J2 in both positions, or one of the positions may be a rest position, such that when the actuator does not apply any effort on the jaw(s), they elastically return in said rest position. Below the jaws J1, J2, the sleeve holder also comprises a support 56. The support 56 is adapted to receive the tip of the drive screw protruding from the second opening 152 of the drive screw sleeve 15. For instance, the support 56 may also receive a portion of the drive screw sleeve 15. The support 56 is, as depicted in the drawings cylindrical with a cavity. The cavity is a blind hole. Once the drive screw sleeve (and the drive screw) is inserted in the support 56, the jaws move from the unlocked position to the locked position. The drive screw sleeve 15 is retained by the jaws J1, J2. The cavity includes a cylindrical pressure spring to push the drive screw upwards within the drive screw sleeve. Thus, when the drive screw sleeve 15 is retained by the jaws J1, J2, the joining tool 12 can be unlocked, such that only the drive screw sleeve and the drive screw remain connected to the transfer station. The cylindrical pressure spring then pushes the drive screw upwards within the drive screw sleeve. The sleeve holder comprises also the first pivot 24 such that the support and the jaws may be rotatably moved between the filling position and the release position. More particularly, in the filling position the support 56 is arranged between the ground and the jaws J1, J2, wherein in the release position, the jaws J1, J2 are arranged between the ground and the support 56.

Just like in the first and second embodiments disclosed above, the transfer station 10 may comprise the collecting tray 38 arranged below the sleeve holder 18 and adapted to receive a used drive screw 14.

The transfer station of the second embodiment notably works as follow. The transfer station according to the third embodiment works according to similar steps.

When the drive screw 14 used by the joining tool 12 does not fulfil the requirements needed for the next joining operation, the joining tool 12 may be directed (for instance by an industrial robot arm) toward the transfer station 10. The joining head of the joining tool 12 is first aligned with the sleeve holder 18 (and more particularly the cut-out 28) and the drive screw sleeve (with the drive screw inside) is inserted within the sleeve holder (and more particularly within the cut-out) such that the sleeve locking profile 154 engages the holder locking profile 261. The sleeve holder 18 is able to move elastically downwards to allow the locking profiles 154, 261 (for instance the multi-tooth profiles) to engage with each other. The tip of the drive screw 14 (which protrudes from the drive screw sleeve) then contact for instance the spring-loaded sheet 32 (as depicted in FIG. 19). The sleeve locking profile 154 and/or the holder locking profile 261 are adapted to apply a counter torque while assembling and disassembling the drive screw sleeve 15. The drive screw sleeve 15 and the drive screw 14 are then disengaged or disconnected from the rest of the joining head, such that the joining tool 12 can be moved back to another position at (short) distance from the transfer station 10, wherein the drive screw sleeve 15 and the drive screw 14 stay connected to the transfer station 10, as shown in FIG. 18. During this step, the filling unit 20 is in the retracted position (i.e. the filling unit is retracted with regard to the sleeve holder), such that the joining head can easily access the sleeve holder 18.

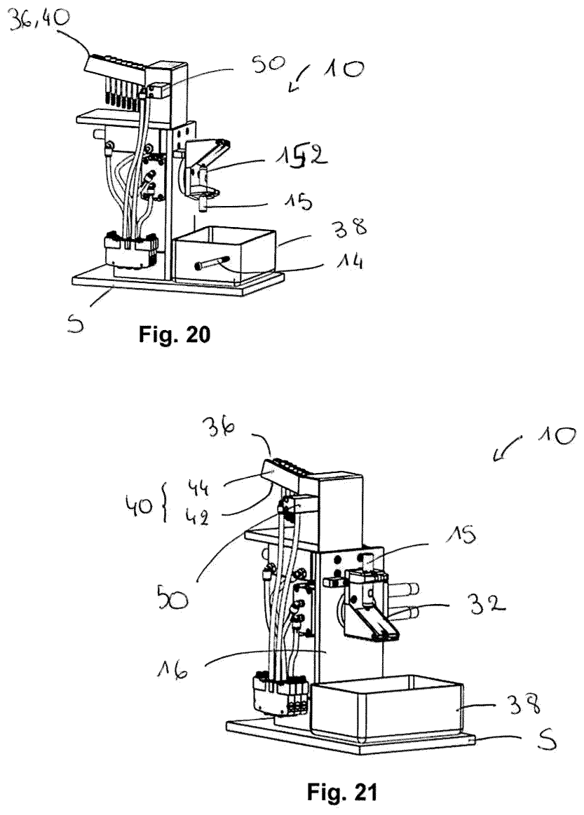

In a subsequent step, as depicted in FIG. 19, the spring-loaded sheet 32 may apply a force on the tip of the drive screw 14 protruding from the drive screw sleeve 15, such that the drive screw 14 is loose within the drive screw sleeve 15. The sleeve holder 18 can then move from a receiving position (which can correspond to the filling position mentioned above) to a release position. More particularly, the sleeve holder 18 rotates, for example at an angle of 180 degrees, such that the drive screw 14 can fall (by gravity) from the drive screw sleeve 15 into the collecting tray 38, as illustrated in FIG. 20, or any other apparatus adapted to collect the used drive screw. Once the used drive screw 14 has fallen and the drive screw sleeve 15 is empty, the sleeve holder 18 can turn back in its filling position (as seen in FIG. 21). The sleeve holder 18 is now ready to receive a new drive screw 14.

In order to fill the drive screw sleeve 15 with the new drive screw 14, the drawer 48 can first isolate one drive screw from the plurality of drive screws 14 arranged on the rail 40 (see for instance FIG. 23). More particularly, the new drive screw 14 falls by gravity within the recess 52 of the drawer 48. The drawer 48 is then actuated from the takeover position to the handover position (see arrow A).

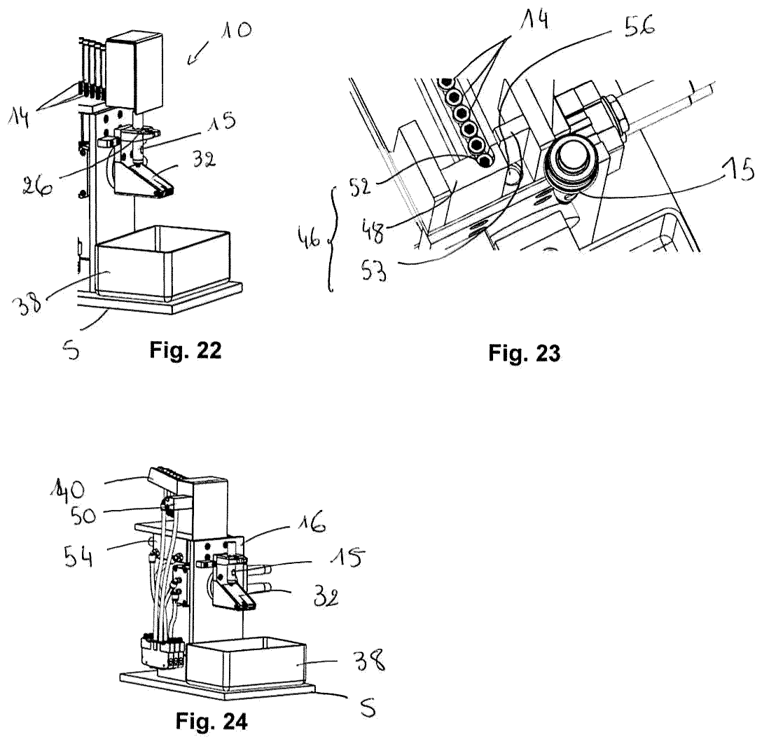

Subsequently or simultaneously, the filling unit 20 and/or the drawer 48 is moved by the second actuator 54 such that the filling unit 20 and/or the drawer 48 moves from the retracted position to the fill position. In the fill position the filling unit 20 and/or the drawer 48 is arranged above the sleeve holder 18 (see FIG. 22).

When the filling unit 20 and/or the drawer 48 is in the fill position and the drawer 48 is in the handover position, the hole 56 of the transfer housing 53 is aligned with the recess 52 and with the longitudinal axis of the drive screw sleeve 15. The new drive screw 14 can fall from the recess 52 into the drive screw sleeve 15 (FIG. 22).

The filling unit 20 then goes back to the retracted position, as seen in FIG. 24, such that the joining tool 12 can come back to re-engage the drive screw sleeve 15 and the new drive screw 14. After re-engagement, the joining tool 12 can disconnect the drive screw sleeve from the sleeve holder 18 and go back to perform the next joining operation.

### NUMERICAL REFERENCES

transfer station 10
joining tool 12
drive screws 14
shaft 141
flange 142
a threaded segment 143
drive screw sleeve 15
a first opening 151
a second opening 152
sleeve locking profile 154
vertical axis X
housing 16
first part 161
second part 162
sleeve holder 18
filling unit 20
holder housing 22
first wall 24
cut-out 26
holder locking profile 261
second wall 28
third wall 30
spring loaded sheet 32
first pivot 34
magazine 36
collecting tray 38
rail 40
base 42
flanges 44
rail axis Xr
transfer apparatus 46
drawer 48
actuator 50
recess 52
transfer housing 53
hole 56
second actuator 54
first and a second jaw J1, J2
jaw actuator A
support 56
elastic connection 60
carriage 58
transfer axis Xt
holder axis Xh
centring and guiding elements 62
guiding plate 64
recess 66
pins 68
feet 163
first part housing 161
second part housing 162

What is claimed is:

1. A transfer station for storing a plurality of drive screws, wherein a drive screw can be taken out of the transfer station by a joining tool comprising a sleeve adapted to receive the drive screw to carry out at least one joining operation which uses the drive screw, the transfer station comprising:
a housing longitudinally extending in height along a vertical axis X, in width along a horizontal axis Y and in depth along a depth axis Z;
a sleeve holder movably connected to the housing, the sleeve holder being adapted to hold and release the sleeve of the joining tool;
a magazine adapted to store the plurality of drive screws; and wherein the sleeve holder is movable between:
an attachment position where the sleeve holder may remove or reinstall the sleeve of the joining tool;
a filling position where an empty sleeve held by the sleeve holder may receive a drive screw; and
a release position where a drive sleeve held by the sleeve holder may remove a drive screw.

2. The transfer station according to claim 1, wherein the sleeve holder is movable in rotation relative to the housing around a holder axis between the release position and the attachment position.

3. The transfer station according to claim 2, wherein the sleeve holder is movable in translation relative to the housing along a transfer axis between the filling position and the attachment position.

4. The transfer station according to claim 3, wherein the holder axis is parallel to the transfer axis.

5. The transfer station according to claim 1, wherein the sleeve holder comprises jaws adapted to grip the sleeve of the joining tool.

6. The transfer station according to claim 5, wherein the jaws are mounted on a carriage, and the carriage is movable in translation relative to the housing.

7. The transfer station according to claim 6, wherein the jaws are connected to the carriage by a first pivot.

8. The transfer station according to claim 1, wherein the magazine comprises a rail longitudinally extending along a rail axis, and the rail axis is oriented relative to the vertical axis at an angle in the range of 45 degrees to 85 degrees.

9. The transfer station according to claim 1, wherein a transfer apparatus is provided at one end of the rail, and the transfer apparatus is arranged between the rail and the sleeve holder when the sleeve holder is in the filling position.

10. The transfer station according to claim 1, and further comprising a collecting tray for collecting a used drive screw, and the collecting tray is arranged below and facing the sleeve holder such that when the sleeve holder is in the release position, a drive screw can fall out of the sleeve into the collecting tray.

11. The transfer station according to claim 1, wherein the housing comprises a first structure elastically assembled to a second structure.

12. A joining system comprising:
a joining tool with a drive screw and a drive screw sleeve, and the drive screw sleeve is detachable from the joining tool and the drive screw is removable from the drive screw sleeve;
a transfer station comprising:
a housing longitudinally extending in height along a vertical axis X, in width along a horizontal axis Y and in depth along a depth axis Z,
a magazine adapted to store a plurality of replacement drive screws,
a sleeve holder movably connected to the housing, the sleeve holder being operable to hold or release the drive screw sleeve of the joining tool,
wherein the sleeve holder is movable between an attachment position, a filling position, and a release position; and
wherein the sleeve holder and the drive screw sleeve have complementary locking profiles.

13. The joining system according to claim 12, wherein the housing comprises a guiding element to align the joining tool with the sleeve and the sleeve holder.

14. The joining system according to claim 12, further comprising a plurality of drive screws arranged in the magazine, and the drive screws each comprises a shaft and a flange, and the flange is supported by the magazine and the shaft protrudes from the magazine, and the shafts extend parallel to the vertical axis.

15. A method for changing a drive screw of a joining tool, the method comprising the steps of:
providing a joining tool with a first drive screw arranged into a drive screw sleeve;
providing a transfer station comprising:
a housing longitudinally extending in height along a vertical axis X, in width along a horizontal axis Y and in depth along a depth axis Z;
a magazine adapted to store a plurality of replacement drive screws,
a sleeve holder movably connected to the housing, the sleeve holder being operable to hold and release the drive screw sleeve of the joining tool,
wherein the sleeve holder is movable between an attachment position, a filling position and a release position;
providing a second drive screw arranged in the magazine;
moving the joining tool to the transfer station and inserting the drive screw sleeve into the sleeve holder in the attachment position;
locking the drive screw sleeve to the sleeve holder;
disconnecting the drive screw sleeve and the first drive screw from the joining tool;
moving the joining tool without the drive screw sleeve and the first drive screw to a non-zero distance from the transfer station;
moving the sleeve holder from the attachment position to the release position then releasing the first drive screw from the drive screw sleeve;
moving the sleeve holder from the release position to the filling position;
transferring the second drive screw from the magazine into the drive screw sleeve;
moving the sleeve holder from the filling position to the attachment position;
reconnecting the drive screw sleeve to the joining tool; and
releasing the drive screw sleeve from the sleeve holder such that the joining tool is again operable to carry out a joining operation using the second drive screw.

16. A joining system comprising:
a joining tool comprising:
a joining head;
a drive screw sleeve detachable from the joining head and including an exterior first profile;
a first drive screw residing in and detachable from the drive screw sleeve;
a transfer station comprising:
a housing longitudinally defining a vertical axis;
a sleeve holder movably connected to the housing, the sleeve holder operable to hold or release the drive screw sleeve of the joining tool, and the sleeve holder is movable between an attachment position and a release position;
a filling unit mounted to the transfer station and comprising:
a magazine adapted to store a second drive screw;
a transfer drawer operable for moving the second drive screw from the magazine to the drive screw sleeve; and
the joining tool is movable to the transfer station where the sleeve holder in the attachment position is operable for detaching or reattaching the drive screw sleeve from the joining head.

17. The joining system according to claim 16 wherein the sleeve holder comprises:
a jaw including a second profile compatible with the first profile of the drive screw sleeve for preventing relative rotation, and the jaw is movable in translation by an actuator between a closed position for holding the drive screw sleeve and an open position for releasing the drive screw sleeve; and
a pivot mounting the jaw and rotatable between an up position and a down position, and in the down position the first drive screw can be detached from the drive screw sleeve when the drive screw sleeve is in the sleeve holder.

18. The joining system according to claim 17 wherein the sleeve holder further comprises a carriage mounting the jaw and the pivot, and the carriage is movable in translation from the attachment position, wherein the jaw is located to detach or reattach the drive screw sleeve from the tool head, to a filling position, wherein the jaw is located to receive the second drive screw from the magazine into the drive screw sleeve.

19. The joining system according to claim 16 wherein the housing of the transfer station further comprises:
a lower housing mounting the sleeve holder; and
an upper housing movably mounted to the lower housing and including guides for aligning the tool head when docked with the sleeve holder when in the attachment position.

20. The joining system according to claim 16, wherein:
the magazine of the filling unit further comprises a rail along which the second drive screw moves toward the transfer drawer; and
the transfer drawer is movable by an actuator from a takeover position, where the transfer drawer receives the second drive screw from the magazine, to a handover position where the transfer drawer drops the second drive screw through a hole into the drive screw sleeve.
